(19) United States
(12) Patent Application Publication
(10) Pub. No.: US 2024/0007756 A1
(43) Pub. Date: Jan. 4, 2024

(54) SYSTEMS, METHODS, AND DEVICES FOR IMAGE PROCESSING

(71) Applicant: FlightSafety International Inc., MELVILLE, NY (US)

(72) Inventors: David Michael Emig, St. Louis, MO (US); Mark Andrew Carter, St. Louis, MO (US); Brock Alan Ebert, Kirksville, MO (US)

(21) Appl. No.: 18/345,447

(22) Filed: Jun. 30, 2023

Related U.S. Application Data
(60) Provisional application No. 63/357,279, filed on Jun. 30, 2022.

(51) Int. Cl. H04N 23/74; H04N 17/00

(52) U.S. Cl. CPC H04N 23/74; H04N 17/002

(57) ABSTRACT

A method of reducing light pollution in a scene rendered on a display comprises receiving a portion of a scene to be displayed on a display with an initial luminance, adjusting the initial luminance for the portion of the scene to a final luminance based on a light pollution model associated with the display, and rendering the scene to the display with the portion of the scene having the final luminance.

### CROSS REFERENCE TO RELATED APPLICATIONS

This application claims priority to and the benefit of U.S. Provisional Patent Application 63/357,279, filed on Jun. 30, 2022, the entire contents of which are incorporated herein by reference.

### FIELD

The present disclosure is generally directed to systems, methods, and devices for image processing to, for example, reduce light pollution in a displayed image or scene.

### BACKGROUND

The quality of an image displayed on a display is subject to hardware and/or software capabilities of a display system. Some characteristics that affect the quality of an image displayed on a display include resolution, contrast ratio, brightness, and/or the like. Image processing techniques may be used to adjust characteristics of an image to improve the quality of the image when displayed on the display.

### SUMMARY

Additional features and advantages are described herein and will be apparent from the following description and the figures.

At least one embodiment of the present disclosure is directed to a method of reducing light pollution in a displayed image. The method may include receiving a portion of a scene to be displayed on a display with an initial luminance; adjusting the initial luminance for the portion of the scene to a final luminance based on a light pollution model associated with the display; and rendering the scene to the display with the portion of the scene having the final luminance.

At least one embodiment of the present disclosure is directed to an apparatus for reducing light pollution in a displayed image. The apparatus may include processing circuitry to: receive a portion of a scene to be displayed on a display with an initial luminance; adjust the initial luminance for the portion of the scene to a final luminance based on a light pollution model associated with the display; and render the scene to the display with the portion of the scene having the final luminance.

At least one embodiment of the present disclosure is directed to a system to reduce light pollution in a displayed image. The system may include processing circuitry to: determine initial luminances for pixels in each frame of a plurality of frames of a video signal to be displayed on a display; adjust, on a frame-by-frame basis, the initial luminances for the pixels in each frame to final luminances based on a light pollution model that compensates for light pollution that occurs when each frame is displayed on the display; and render each frame to the display with the pixels having the final luminances.

At least one embodiment of the present disclosure is directed to a method for calibrating a display system. The method includes: displaying a calibration image on a display; capturing, with one or more image sensors, the calibration image displayed on the display; determining light pollution for zones of the calibration image based on the captured calibration image; and generating a light pollution model based on the determined light pollution for the zones.

At least one embodiment of the present disclosure is directed to a system comprising: a screen; one or more projectors that project images onto the screen; one or more image sensors; and image processing circuitry to: render a calibration image to the screen using the one or more projectors; control the one or more image sensors to capture the calibration image displayed on the screen; determine light pollution for zones of the calibration image based on the captured calibration image; and generate a light pollution model based on the determined light pollution for the zones.

### BRIEF DESCRIPTION OF THE DRAWINGS

The present disclosure is described in conjunction with the appended figures, which are not necessarily drawn to scale.

FIG. 1 illustrates a display system according to at least one example embodiment.

FIG. 2 illustrates various example implementations of the display system in FIG. 1.

FIG. 3 illustrates example patterns for calibration images according to at least one example embodiment.

FIG. 4 illustrates a method according to at least one example embodiment.

FIG. 5 illustrates a method according to at least one example embodiment.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a PCB, or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The terms “determine,” “calculate,” and “compute,” and variations thereof, as used herein, are used interchangeably and include any appropriate type of methodology, process, operation, or technique.

Various aspects of the present disclosure will be described herein with reference to drawings that may be schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “include,” “including,” “includes,” “comprise,” “comprises,” and/or “comprising,” when used in this specification, specify the presence of stated features, integers, stages, operations, elements, and/or components, but do not preclude the presence or addition of one or more other features, integers, stages, operations, elements, components, and/or groups thereof. The term “and/or” includes any and all combinations of one or more of the associated listed items.

Where reference to general element or set of elements is appropriate instead of a specific element, the description may refer to the element or set of elements by its root term. For example, when reference to a specific element Xa, Xb, Xc, etc. is not necessary, the description may refer to the element(s) in general as “X.”

Example embodiments generally relate to predicting and overcoming fill factor dependent contrast loss in a displayed image. The instantaneous range of displayable luminance, a.k.a. system Contrast Ratio (CR), provided to the Eye Point (EP) of a collimated, Level-D, flight simulator is dictated by a multitude of optical and geometric limitations. Although these limitations are often necessary compromises in order to achieve the desired Field of View (FOV), peak luminance (a.k.a. white level) and luminance uniformity, the magnitude of the CR reduction, and the magnitude of subsequent greyscale distortions, a.k.a. “washout,” are determined by the relative luminance of the displayed FOV, a.k.a. the fill factor (FF). Example embodiments provide a process to estimate, for a given input image, the impact of FF on system CR and the corresponding washout of greyscales near the system's black level, which can be obtained with a simulated washout version of the input image. The Just-Noticeable Difference (JND) between displayed luminance levels and the system black level is then estimated and the washout image is analyzed. The washout creates significant visually indifferentiable regions, and regions of significant greyscale nonlinearity. A system level solution is proposed in order to recapture and retune these lost and distorted greyscales. The system approach introduces a dynamic FF-dependent Tone Map (TM) operator uniquely enabled by the Image Generator (IG) or image processor.

Projector contrast ratios CRs (CR_{PJ}) range from 1000:1 to 500000:1, while system CRs measure on the order of 10:1. The difference in these measurements is the Fill Factor (FF) of the applied test pattern. Projector CR is commonly referenced in terms of its “sequential” CR, where luminances of full-white and full-black patterns are measured consecutively and their results divided. System CR, however, is measured using a checkerboard of white and black squares. For a given image, commanded by the IG and then converted to greyscale, the FF is defined as the sum of the commanded greyscale values from all pixels divided by the same sum of a full white image. The FF may range from 0.0 to 1.0 depending on the test pattern. Given this definition, a sequential CR measurement represents a limiting case, wherein the FF approaches zero and CR is maximized. The standard checkerboard pattern (an image of half black and half white blocks of equal sizes), however, has a relative commanded luminance of 0.5 and equivalently a FF of 0.5 (or CR_{0.5}). This higher fill factor provides a notably lower CR.

A multitude of factors limit the CR efficiency of collimated display systems. For a typical rear-projected Level-D flight simulation system, limiting factors encountered from image creation to image observation may include image generator capability, alignment system capability, projector capability and native contrast, the efficiency of the imaging optics (lenses), projection screen related parameters like specular reflection and diffuse reflection, ambient light, and a human's visual abilities.

As FF increases, the amount of light in the system increases, which in turn increases the magnitude of light scattered and reflected from components between the IG (for example, a projector's imaging panel) and the Eye Point. Although some of this scattered and reflected light can be reduced or eliminated by careful system layout and optically absorptive baffling around the projection screen and lenses, a sizeable portion cannot be captured without degrading critical system performance parameters such as FOV and luminance uniformity. A portion of this unblocked light strikes the imaging surface of the projection screen and creates unwanted light leakage, L_{N}.

In order to provide adequate luminance uniformity for an image consisting of light projected from a wide variety of angles, a projection screen in a typical collimated system has relatively broad scattering and reflection profiles. These profiles tend to broadly distribute and receive wanted and unwanted light. As a result, it can be reasonably assumed that unwanted light from a given pixel is nearly uniformly distributed across all other pixels within the FOV. This uniformly increases the system black level by L_{N}.

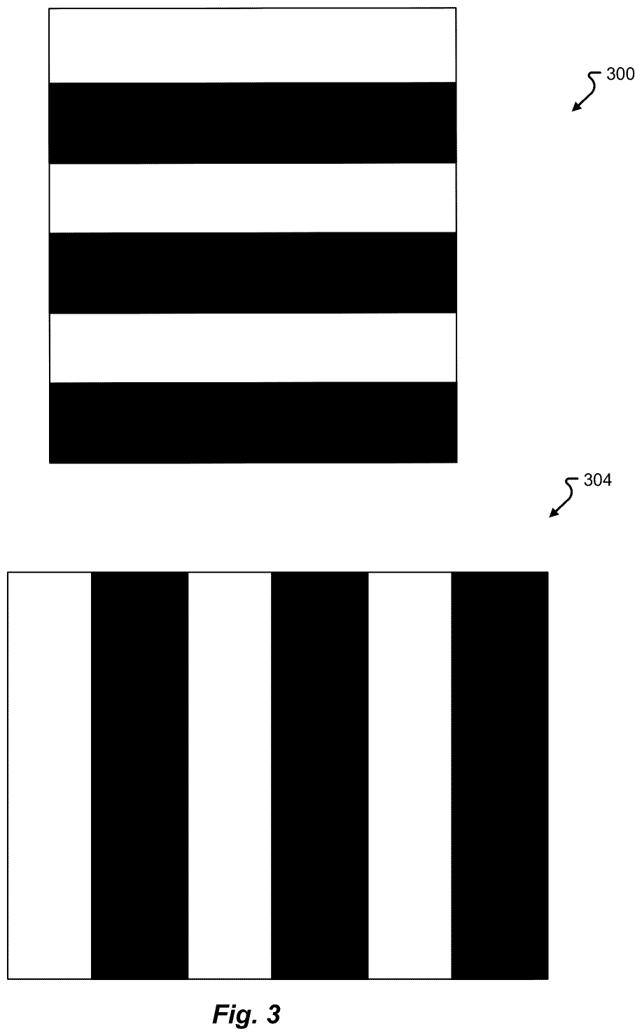

The assumption of uniform scattering greatly simplifies the computation of system CR for a given FF. This is shown in the formula below, wherein L_{w} and L_{b} represent projector white and black levels respectively. The white and black levels measured at the Eye Point, for a test pattern such as those shown in FIG. 3, are then represented by (L_{w}+L_{N}) and (L_{b}+L_{N}), respectively.

$$C {R}_{s y s} = \frac{{L}_{w} + {L}_{N}}{{L}_{b} + {L}_{N}}$$

In practice, the L_{N} terms in the numerator and denominator are not perfectly equal, and their ratio determines the degree to which the unwanted scattered light is uniformly distributed. Consequently, the ratio of these terms should provide a correlation metric indicating the degree to which the uniform scattering model is successful at representing system contrast in a given application.

The broad scattering and reflection profiles employed in collimated display systems justify the presumption that unwanted light is uniformly scattered to produce a uniform L_{N}, even for complex images with unbalanced luminance distributions. Example embodiments related to generating a light pollution model reasonably assume that the computed FF for a given FOV in a collimated display system will produce approximately the same amount of L_{N} as a black and white test pattern with the same FF. This then enables straightforward collection of validation data in order to verify the model's applicability, such as that which is provided in the ensuing sections.

A formulaic representation of FF dependent system CR is shown below, wherein C_{sys} is a contrast coefficient which uniquely determines the magnitude of CR limitation by regulating contributions from L_{N}. The ambient luminance (L_{A}) is not sourced from L_{w} or L_{b}. For collimated display systems, ambient luminance L_{A} is usually negligible. Generally speaking, ambient luminance may be of greater importance for large FOV systems.

$$C {R}_{s y s} = \frac{{L}_{w} + {L}_{N}}{{L}_{b} + {L}_{N}}$$

$${L}_{N} = \frac{1}{{C}_{s y s}} [ F F * {L}_{w} + ( 1 - F F ) * {L}_{b} ] + {L}_{A}$$

The sequential contrast of the projector (CRₚⱼ) can be assumed to represent the relationship between input Lw and Lb values.

$$C {R}_{pj} = \frac{{L}_{w}}{{L}_{b}}$$

The contrast coefficient C_{sys} can therefore be related to the system checkerboard CR, CR_{0.5}, as follows. This is quite useful as the checkerboard CR of the display system is regularly known or measured.

$${C}_{s y s} = \frac{C {R}_{0.5} ( C {R}_{pj} + 1 ) - C {R}_{PJ} - 1}{2 ( C {R}_{PJ} + C {R}_{0.5} )}$$

The system CR as a function of FF for a particular system can thus be uniquely determined, within the stated approximation, by CR_{PJ}, CR_{0.5}, and where necessary, L_{A}.

The model confirms expectations that system CR is dramatically impacted by FF, but FF values for common flight training tasks practiced in a flight simulator are still largely unknown. The relationship between FF and the Time of Day (TOD) for a given scene is useful for understanding the impact of FF on flight training tasks.

The system CR computation reasonably presumes a FF which represents the entire system FOV. The ensuing description on occasion describes the partial FOV provided by a single projection channel (a single projector). The examples described herein were performed with a 180° horizontal and 40° vertical FOV representative of Level-D standards for a flight simulator.

A pilot's ability to discern, and eventually identify, task-critical surfaces and objects is determined in large part by system CR. During near ground maneuvers, such as take-off and landing, adequate system contrast is particularly crucial for the identification of light points, runway markings and related indications. At Decision Height (DH), adequate system contrast can mean the difference between a safe landing and a missed approach. The table below shows estimates for FF range per TOD at DH for 64 combinations of varying luminance, celestial and weather controls.

| Time Of Day | Fill Factor | System CR |
|---|---|---|
| DH at Night | 0.005~0.1% | 10,000~2500 |
| DH at Dawn/Dusk | 0.5~3.5% | 700~100 |
| DH at Day-scene | 8~45% | 45~9 |

The corresponding system CR estimates provided in the table above imply that night scenes benefit from the relatively high sequential CR provided by the projector. For other TODs, the unwanted light added to the imaging surface (i.e., the projection screen) significantly exceeds the initial black level of the projector. As a result, an increase in projector sequential CR is only likely to be observable for night scenes. For DH applications, the system CR for dawn, dusk and day scenarios can be significantly improved by an increase in display system CR, most likely achieved by enhancing the CR of the projection screen.

When FF increases, system CR drops, and the system black level increases. If the image generator does not compensate for the system's dynamic CR, and presumes a high, static CR such as the sequential CR of the projector, then this increased black level has the potential to render content of a very dark scene invisible. Content just above this level will also suffer an unintended greyscale compression which distorts the intended Tone Map (TM) operator and creates visual nonlinearity in the perceived grey levels. This effect, the loss of dark grey levels and the nonlinear distortion of levels just above, is referred to as system washout. System washout is driven by system CR and depends heavily upon the FF for a given image. System washout has a significant impact on the range and accuracy of displayed luminance, particularly if the image generator presumes a static system CR.

In addition to losing scene content, compression of the luminance difference between adjacent greyscales near the system black level can significantly reduce the resolvability of visual cues in the affected regions. The visibility of textures, and to some extent the visibility of critical runway markings, are also degraded by system washout.

A FF-dependent TM operator according to inventive concepts may restore linearity to greyscales which are otherwise unnaturally compressed or completely invisible. Since the image generator possesses instantaneous image data for the entire FOV, and the output of the image generator is tuned to the luminance and chromaticity of the particular simulator by a manual or automated alignment system, the image generator may be uniquely capable of executing a FF-dependent TM operator in order to restore the visible luminances previously lost to system washout. It is possible to provide a representation within the IG of the system black level, observer's adaptation luminance, and luminance JND for any particular image. A non-linear correction can thus be applied to the TM operator which effectively magnifies the intensity of the lost and distorted greyscales, until a visually linear output is achieved. Commandable bit depth may still be lost to system washout, but the intended resolvability of darker luminance regions is largely restored through the re-linearization provided by a FF-dependent TM.

The application of a FF-dependent TM operator in real-time has the potential to introduce visual artifacts for rapidly changing scene content. Also, any significant change in the TM should be employed over a visually indiscernible period, possibly several seconds. As a result, the proposed methods are best employed as a means to provide deterministic, psychophysically-based, restoration of otherwise lost or distorted dark greyscales across a truly continuous range of TOD.

Example embodiments relate to a system level approach that restores grey levels lost to system washout, where the alignment system identifies a projector's sequential CR and the image generator employs FF-dependent models to yield a continuous representation of the entire visual FOV. This enables the image generator to provide a customized TM operator for the instantaneous image.

In order to yield a sufficiently large FOV and/or high resolution image, visual display systems may employ multiple projectors configured such that their projected images overlap. In order for the resultant image to appear homogenous, each component image must have a correction for spatial and radiometric non-uniformities. In applications with relatively large FOVs (between 40 and 360 degrees wide, for example) such as flight simulator visual display systems, these corrections are computed by an Alignment System (AS), and executed by an AS and/or and Image Generator (IG) (e.g., an image processor).

Correction of static non-uniformities is well known and practiced, but correction of dynamic non-uniformities, such as light pollution between adjacent pixels, is not. As scenes displayed on the projection screen change, the amount and location of light pollution also changes, yielding an ever-changing washout luminance which degrades scene contrast and displayable luminance range. This is a performance limiting factor for day, dusk and dawn scenes, as the overall luminance is appreciable.

The instantaneous displayable luminance range can be significantly improved by increasing the contrast ratio of the projection screen. However, increasing the contrast ratio negatively impacts luminance, and in many systems negatively impacts the life-cycle cost, by shortening projector light source lifetime. Fortunately, in flight simulation applications the reduction in instantaneous luminance range generally has little impact to scene fidelity. This is because of the great distance between the pilot and objects out the window. Even in the best of weather (such as Ceiling and Visibility Unlimited (C.A.V.U.)) atmospheric attenuation is appreciable within the scene, and as a result, a black object will be dark grey due to atmospheric scattering. This means that within these scenes a pixel is seldom, if ever, commanded to display black, and so the luminance range is generally not realized for this content, and not a significant performance limiting factor.

The reduction in scene contrast due to washout luminance is appreciable. Each scene employs a multitude of grey-to-grey contrasts, many of which are on the order of the washout luminance, which may shift the perceived location of a grey-gradient within the image by a negligible amount (e.g., a fraction of a pixel) but it can also result in the loss of fine details or the premature loss of a ranged-out target due to reduced grey-to-grey Modulation Transfer Function (MTF). This is recognized by the industry and the contrast ratio of visual display systems is a regulated parameter.

Inventive concepts employ software and hardware to improve scene contrast. Since the contrast ratio is generally measured as a ratio of black and white, it is unaffected by the Light Pollution Correction (LPC). Direct measurement of contrast within the scene, however, quantifies the benefit, and shows it to be comparable to at least a doubling of contrast ratio. In order to maintain the scene contrast benefit, the LPC must be recomputed for each scene, often at 120 Hz. LPC also performs best with a complete light pollution characterization, in order to optimally predict the scene's instantaneous light pollution per-pixel.

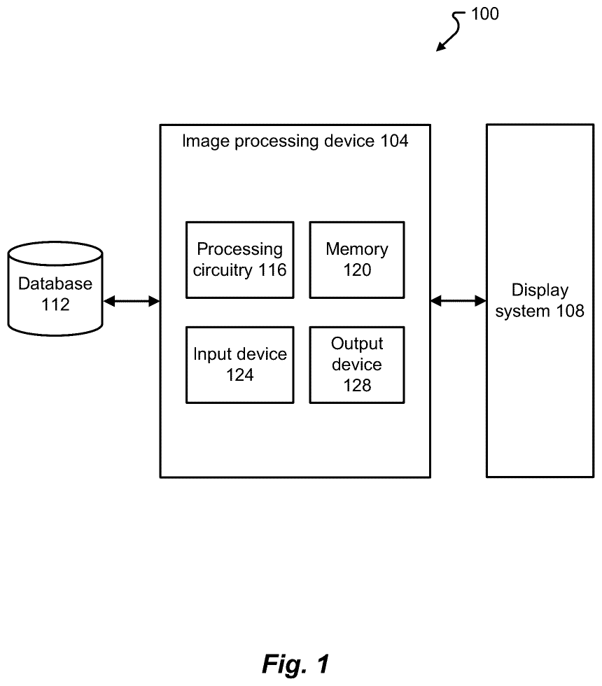

FIG. 1 illustrates a system 100 according to at least one example embodiment. The system 100 includes an image processing device (also referred to herein as a device or an image generator or an image processor) 104, a display system 108, and a database 112.

In at least one example embodiment, device 104 corresponds to one or more of a Personal Computer (PC), a laptop, a tablet, a smartphone, a server, a collection of servers, or the like. In some embodiments, the device 104 may correspond to any appropriate type of device that communicates with other devices also connected to a common type of communication network. As another specific but non-limiting example, the device 104 may correspond to servers offering information resources, services and/or applications to user devices, client devices, or other hosts in the system 100. In at least one example embodiment, the device 104 comprises any suitable device that generates, receives, stores, and/or processes moving and/or still images.

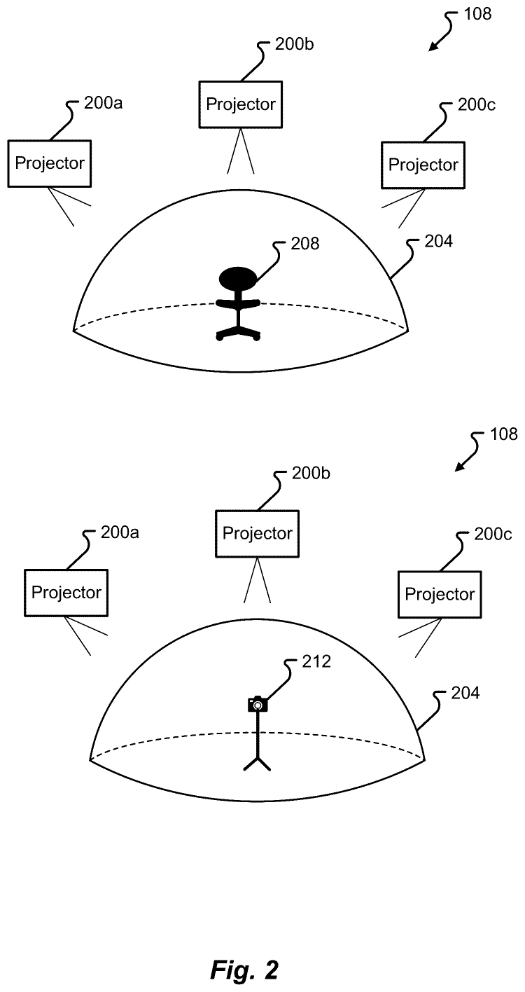

The display system 108 includes one or more displays to display moving and/or still images received from the image processing device 104. The display system 108 may include any suitable type of display, such as a liquid crystal display (LCD), a light emitting diode (LED) display, and/or the like. The display system 108 may comprise one or more stand-alone devices or devices integrated as part of another device, such as a smart phone, a laptop, a tablet, and/or the like. The display system 108 may be integrated with the device 104. In one non-limiting embodiment, the display system 108 is integrated with a flight simulator and comprises one or more screens and one or more projectors that project images onto the one or more screens (see FIG. 2, for example). In this case, the one or more screens may comprise a full or partial dome or dome-like structure (e.g., made of acrylic material) that is back lit by the one or more projectors. For example, a screen according to at least one embodiment enables a 360-degree or near 360-degree horizontal field of view and a 135-degree or near 135-degree vertical field of view. In another example, the screen enables a 180-degree or near 180-degree horizontal field of view and a 40-degree or near 40-degree vertical field of view. Example embodiments are not limited to the above types of displays and/or the above-mentioned fields of view and any suitable display with any suitable field of view may be used for the display system 108.

Database 112 may comprise any suitable type of memory device or collection of memory devices configured to store data. Non-limiting examples of suitable memory devices that may be used include Flash memory, Random Access Memory (RAM), Read Only Memory (ROM), variants thereof, combinations thereof, or the like. The database 112 may be remote from or local to the device 104 and/or the display system 108. In at least one embodiment, the database 112 stores a light pollution model and information related thereto. The light pollution model is discussed in more detail below with reference to the remaining figures, but may include a dataset that has a light pollution value for each pixel displayed on a display of the display system 108. The light pollution value for a pixel may be indicative of an amount of light pollution experienced by that pixel (e.g., light pollution from ambient light and/or other pixels). The light pollution model may be used to generate a set of correction factors that may be applied when generating an image so that light pollution is reduced or eliminated from the image when displayed on the display. A correction factor may be generated for each pixel of the display so that light pollution for each pixel is reduced or eliminated. In at least one example, the light pollution model includes scattering coefficients computed for each pixel of the display which may be later used to determine correction factors for the pixels.

The device 104, display system 108, and database 112 may be communicative coupled to one another by a communication network. The communication network may comprise a wired network and/or a wireless network that enables wired and/or wireless communication within the system 100. Examples of the communication network that may be used include an Internet Protocol (IP) network, an Ethernet network, an InfiniB and (IB) network, a Fibre Channel network, the Internet, a cellular communication network, a wireless communication network, combinations thereof (e.g., Fibre Channel over Ethernet), variants thereof, and/or the like. The communication network may enable wireless communication using one or more protocols in the 802.11 suite of protocols, near-field communication (NFC) protocols, Bluetooth protocols, LTE protocols, 5G protocols, and/or the like. The device 104, display system 108, and database 112 may include one or more communication interfaces to facilitate wired and/or wireless communication over the communication network. The device 104 and display system 108 may be connected to one another with any suitable connection for carrying video and/or audio signals, for example, a HDMI connection, DisplayPort connection, an RS232 connection, BNC connection, RJ45 connection, and/or the like.

Although the device 104, display system 108, and database 112 are shown as separate entities communicating over a communication network, it should be appreciated that these elements may be incorporated into a single device (e.g., a server, a personal computer, and/or the like).

The processing circuitry 116 may comprise suitable software, hardware, or a combination thereof for processing images from source device 104 and carrying out other types of computing tasks. The processing circuitry 116 may carry out the various image processing operations and algorithms described herein. The memory 120 may include executable instructions and the processing circuitry 116 may execute the instructions on the memory 120. Thus, the processing circuitry 116 may include a microprocessor, microcontroller, and/or the like to execute the instructions on the memory 120. The memory 120 may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory 120 and processing circuitry 116 may be integrated into a common device (e.g., a microprocessor may include integrated memory). Additionally or alternatively, the processing circuitry 116 may comprise hardware, such as an application specific integrated circuit (ASIC). Other non-limiting examples of the processing circuitry 116 include an Integrated Circuit (IC) chip, a Central Processing Unit (CPU), a Graphics Processing Unit (GPU), a Field Programmable Gate Array (FPGA), a digital signal processor (DSP), a collection of logic gates or transistors, resistors, capacitors, inductors, diodes, or the like. Some or all of the processing circuitry 116 may be provided on a Printed Circuit Board (PCB) or collection of PCBs. It should be appreciated that any appropriate type of electrical component or collection of electrical components may be suitable for inclusion in the processing circuitry 116. The processing circuitry 116 may send and/or receive signals to and/or from other elements of the system 100 to control various operations for the system 100.

The input device 124 includes suitable hardware and/or software that enables input to the system 100 (e.g., user input) through device 104. The input device 124 may include a keyboard, a mouse, a touch-sensitive pad, touch-sensitive buttons, a touch-sensitive portion of a display, mechanical buttons, switches, and/or other control elements for providing user input to the system 100 to enable user control over certain functions of the system 100.

The output device 128 may include suitable hardware and/or software that produces visual, audio, and/or tactile feedback for a user or other interested party based on one or more inputs from the processing circuitry 116. In at least one example embodiment, the output device 128 includes one or more displays to display an output image and/or one or more characteristics of an input image after processing of the input image by the device 104. The input image may be based on a source image received from the source device 104 over the communication network. The display may include any suitable type of display, such as a liquid crystal display (LCD), a light emitting diode (LED) display, and/or the like. The output device 128 may be a stand-alone device or a device integrated as part of another device, such as a smart phone, a laptop, a tablet, and/or the like.

Although the input device 124 and the output device 128 are illustrated as being part of the image processing device 104, the input device 124 and/or the output device 128 may be embodied separate from the device 104 according to design preferences of the system 100.

In addition, it should be appreciated that device 104, display system 108, and/or database 112 may include other processing devices, storage devices, and/or communication interfaces generally associated with computing tasks, such as sending and receiving data over a wired and/or wireless connection.

FIG. 2 illustrates various example implementations of the display system 108 in FIG. 1. In more detail, FIG. 2 illustrates two implementations of the display system 108 that may be useful in a flight simulator. As such, the display system 108 in both implementations includes one or more projectors 200a, 200b, and 200c and a display or screen 204 having a dome structure. In operation, the image processing device 104 controls the projectors 200a to 200c to display moving and/or still images on a back side of the screen 204 for viewing by a user seated in one or more seats 208 on a front side of the screen 204 within the dome. In the flight simulator example, the seat 208 may be a pilot's seat and, although not explicitly shown, control panels and other flight instruments associated with a cockpit may be positioned within the dome in proximity to the seat 208 to allow a user sitting in seat 208 to control a simulated flight as depicted on the screen 204.

The bottom implementation of FIG. 2 illustrates one or more image sensors (e.g., cameras) 212 which may be positioned in a central region of the screen 204. As discussed in more detail below, the image sensor(s) 212 may be used to capture one or more calibration images displayed on the screen 204 for the purposes of building a light pollution model that may be stored in database 112. The sensor 212 may operate at a different resolution than one or more of the projectors 200a, 200b, and 200c. For example, in some embodiments, the sensor 212 has a lower resolution than at least one of the projectors 200a, 200b, and 200c.

FIG. 3 illustrates example patterns 300 and 304 for calibration images that may be displayed on the screen 204 by projectors 200a to 200c. As may be appreciated, pattern 300 comprises alternating white and black stripes of equal widths that extend in a horizontal direction on the screen 204 while pattern 304 comprises alternating white and black stripes of equal widths that extend in a vertical direction on the screen 204. Both patterns 300 and 304 comprise a black and white image with a repeating pattern. Here, it should be appreciated that patterns other than those shown in FIG. 3 may be used as a calibration image for building the light pollution model (e.g., a checkered pattern, a dot pattern, a diagonal line pattern, and/or the like). In addition, patterns for a calibration image are not limited to black and white patterns and any suitable combination of colors may be used.

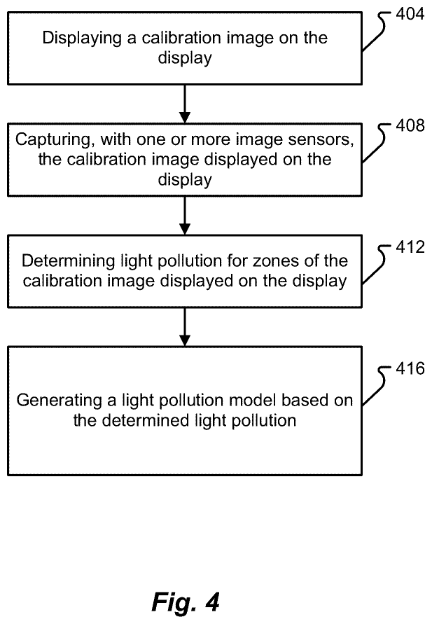

FIG. 4 illustrates a method 400 according to at least one example embodiment.

While a general order for the steps of the method 400 is shown in FIG. 4, the method 400 can include more or fewer steps or can arrange the order of the steps differently than those shown in FIG. 4. The method 400 can be executed as a set of computer-executable instructions encoded or stored on memory 120 and executed by the processing circuitry 116. In another embodiment, one or more of the operations of the method 400 are implemented by processing circuitry 116 that takes the form of an ASIC. The method 400 may be explained with reference to the systems, components, assemblies, devices, user interfaces, environments, software, etc. described in conjunction with FIGS. 1-3. In general, the method of FIG. 4 shows calibration operations performed in order to generate a light pollution model according to inventive concepts.

In general, the light pollution model considers light pollution as unwanted light from a given pixel or group of pixels distributed to other pixels. In at least one embodiment, such unwanted light is assumed to be substantially uniformly distributed across all other pixels in a field of view (e.g., a field of view of a projector). As noted in the discussion prior to the discussion of FIG. 1, fill factor for an image to be displayed may be determined by converting pixel values of the image, as commanded by the image processor 104, to grayscale, summing the grayscale values from all pixels of the image, and dividing that sum by a sum of grayscale values from all pixels of the image in a full white image. The light pollution model may be used to generate correction factors (e.g., tone map operators or luminance adjustments) that can be applied to pixels of a scene during the image generation process, where the correction factors are different based on the anticipated fill factor for that scene. As part of the correction process then, the fill factor of a scene (e.g., a frame) may be determined by converting pixels of the scene to grayscale and dividing the sum of grayscales by the grayscales of a completely white image displayed on the same display as that used to eventually display the scene. Correction factors for pixels of the scene may then retrieved based on the computed fill factor for the scene. As noted above and below, the correction factors may correspond to tone map operators that adjust luminances of the pixels in a manner that eliminates or reduces the light pollution associated with each pixel, thereby increasing the system contrast ratio without needing to increase the sequential contrast ratio of the display or projector.

Operation 404 includes displaying a calibration image on a display, for example, on screen 204. As noted above, the calibration image may be one of the images 300 or 304 from FIG. 3 displayed on the screen 204 by projectors 200a to 200c at the same time. As may be appreciated, each projector 200a to 200c may correspond to a different “display” even though the projectors are cooperating to display a single contiguous scene.

Operation 408 includes capturing, with one or more image sensors 212, the calibration image displayed on the display. For example, the one or more image sensors 212 may be implemented with a camera ball having multiple integrated cameras and/or with multiple individual cameras arranged on a backside of the screen 204. In one non-limiting example, a number of cameras used for a 360-degree screen 204 may be equal to eight, each camera having a same or similar field of view (e.g., 120-degree field of view) oriented toward a respective section of the screen 204. However, a number of cameras and respective fields of view may vary according to design preferences. The camera(s) may be located at a design eye point, which may be a location that corresponds to eye-level of a user seated in a seat 208. In some embodiments, one or more of the camera(s) are aligned with a ray of the design eye point. The camera(s) may capture the calibration image under ambient light conditions that normally exist when the screen 204 is used for flight simulation or other purpose. In another embodiment, the camera(s) capture the calibration image under dark conditions.

Operation 412 includes determining light pollution for zones of the calibration image based on the captured calibration image. For example, the image processing device 104 determines scattering coefficients for zones of the captured calibration image, where each zone of the captured calibration image corresponds to a single pixel or a group of neighboring pixels of the screen 204. In doing so, the image processing device 104 may collect information on the brightest whites and the brightest blacks in the calibration image displayed on screen 204. As may be appreciated, the image processing device 104 may carry out a mapping of pixels in the captured calibration image to pixels of the screen 204 in order to accurately determine scattering coefficients for the pixels of the screen 204. In at least one embodiment, the scattering coefficient for each pixel of the screen 204 may be determined using information related to a known luminance of a pixel of the screen (e.g., the luminance value of the pixel as commanded by the image processing device 104 of a projector 200) and a captured luminance value of the same pixel as captured by the one or more image sensors 212 (a difference between the known luminance value and the captured luminance value of a pixel may be indicative of the scattering coefficient for that pixel). Some examples employ the following pseudocode for determining the scattering coefficients of pixels using two calibration images—a first image that is 50% white and 50% black, such as example one of the image patterns 300 or 304, as captured by image sensor 212, and a second image that is the inverse of the first image (i.e., all white regions in the first regions are black in the second image and all black regions in the first image are white in the second image). Each pixel's darkest and whitest luminance values are measured in each captured image. Such luminance measurements may be linear in nature (e.g., ranging from 0.0 to 1.0), and the resulting scattering coefficient for each pixel is unitless. The pseudocode for computing scattering coefficients in the two captured images is as follows:
for each display d
   for each pixel i

scattering_coefficient[d][i]=2*black[d][i]/(white[d][i]−black[d][i])

Since the scattering coefficient typically changes slowly across the display system, the scattering coefficient can be interpolated from lower resolution measurements (e.g., if using a single calibration image instead of two images as in the example above, then white luminance measurements in black regions of the single image are estimated or interpolated from white luminance measurements in white regions of the image near the black regions and vice versa—for example, black pixels in the image are assigned the same white luminance values as the white pixels nearest to the black pixels (and vice versa for white pixels being assigned black luminance values)). Correction factors may be generated using a single measurement for scattering coefficient determination.

Determining the scattering coefficient for each pixel of the screen 204 based on the captured calibration image is a useful metric for light pollution because the scattering coefficient is substantially independent of the color being displayed for a pixel within the scene. Thus, computing scattering coefficients using a relatively simple black and white calibration image (like image 300 or image 304) is an efficient method for gathering information on the light pollution between neighboring pixels of a color scene displayed on the screen 204. As discussed in more detail below, the scattering coefficients may be used to build a light pollution model that is used to predict and correct for a scene's instantaneous light pollution per-pixel (or per-zone other than a pixel) of the screen 204.

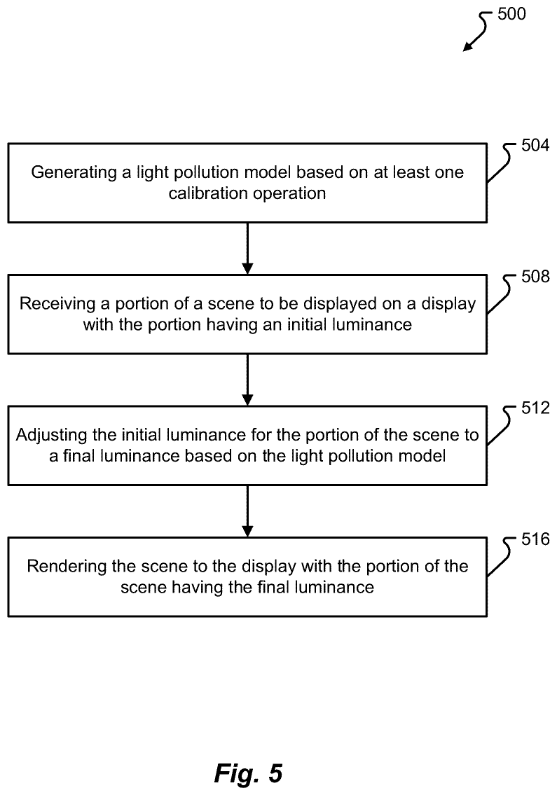

Operation 416 includes generating a light pollution model based on the determined light pollution from operation 412. For example, operation 416 generates the light pollution model based on the computed scattering coefficients. In at least one embodiment and as discussed in more detail below, the light pollution model may be used for generating a correction factor (e.g., luminance adjustment) for each zone (e.g., each pixel) of a displayed image. In at least one example, the light pollution model contains estimations of light pollution across the range of possible fill factors. Stated another way, the fill factor of a display changes as the images being displayed change, and as such, the light pollution model contains a light pollution value for each possible fill factor value. In an example where the fill factor ranges from 0.00 to 1.00, the light pollution model may contain 101 light pollution values—one value for each possible fill factor 0.00, 0.01, 0.02, and so on until 1.00. In at least one embodiment, each light pollution value is a vector “pollution.rgb” and is defined as follows for each pixel i of a display d: pollution.rgb=FillFactor.rgb*scattering_coefficient[d][i]. The FillFactor.rgb of a scene to be displayed on screen 204 by a projector 200 may be computed in real time according to the discussion below in FIG. 5.

As noted above, each zone of the calibration image may correspond to a pixel of the screen 204, and thus, the light pollution model may be used to control luminance adjustments for that pixel, thereby allowing the system to predict and correct for light pollution on a per-pixel basis. The tone map operator may be static for each pixel or variable according to certain conditions.

FIG. 5 illustrates a method 500 according to at least one example embodiment. While a general order for the steps of the method 500 is shown in FIG. 5, the method 500 can include more or fewer steps or can arrange the order of the steps differently than those shown in FIG. 5. The method 500 can be executed as a set of computer-executable instructions encoded or stored on memory 120 and executed by the processing circuitry 116. In another embodiment, one or more of the operations of the method 500 are implemented by processing circuitry 116 that takes the form of an ASIC. The method 500 may be explained with reference to the systems, components, assemblies, devices, user interfaces, environments, software, etc. described in conjunction with FIGS. 1-4. In general, the method of FIG. 5 shows operations performed in order to generate a scene that includes luminance corrections on a per-pixel basis.

Operation 504 includes generating a light pollution model based on at least one calibration operation. Thus, operation 504 may correspond to the method 400 in FIG. 4 that shows details for the at least one calibration operation. As noted above and below, the light pollution model may include light pollution values computed from scattering coefficients for pixels p of displays d and may be used to adjust, in real-time, initial luminances of pixels of a scene to final luminances in order to reduce light pollution like image washout, which in turn increases the effective contrast ratio of the scene when displayed on the screen 204 (recall that the screen 204 may be comprised of multiple displays with each display corresponding to a region of the screen 204 illuminated by a respective a projector 200). Here, it should be appreciated that operation 504 may be skipped or omitted from the method 500 if, for example, the light pollution model has already been generated (e.g., during a previous iteration of method 500 or a separate instance of method 400). In general, the light pollution model may be updated (re-generated) when one or more of components are altered in the system that may affect luminance (e.g., following projector maintenance like a bulb change, projector replacement, projector repositioning, and/or the like).

Operation 508 includes the image processing device 104 receiving a portion of scene that has an initial luminance, for example, as commanded by a video signal or still image signal having the scene. In the event of a video signal (e.g., a 60 hz or 120 hz video signal), the scene may correspond to a frame of the video signal. In this case, operations 508 to 516 may be performed iteratively in real-time so that each frame of the video signal rendered to display system 108 is analyzed and the luminances adjusted in accordance with the light pollution model. In one embodiment, the scene corresponds to a still image to be rendered to display system 108. The portion of the scene may correspond to a single pixel or a group of pixels when the scene is displayed on the display system 108. For example, the portion of the scene may be mapped with a single pixel on the screen 204 or mapped with a group of neighboring pixels on the screen 204. In some cases, operation 508 may include converting image information of the portion of the scene into the initial luminance value and/or determining the initial luminance value for the portion of the scene in a suitable manner.

The portion of the scene may have one or more luminance values, such as linear luminance values ranging from 0.0 to 1.0 (which may have a corresponding rgb luminance value) discussed herein. For example, when the portion of the scene corresponds to a single pixel, the initial luminance of the pixel may correspond to the preset luminance value of the pixel as determined by the image processing device 104 for rendering the scene to the display system 108. In another example, when the portion of the scene corresponds to a group of pixels, the initial luminance may be an average luminance value of the preset luminance values of the pixels, the median luminance value of the preset values of the pixels, and/or another suitable luminance value that accounts for the preset luminance values of one or more of the pixels.

Operation 512 includes adjusting the initial luminance for the portion of the scene to a final luminance based on the light pollution model generated in operation 504. Here, the luminance adjustment may compensate for light pollution on a per-pixel basis that would otherwise occur when the scene is rendered to the display system 108 without luminance adjustment. As noted above, the light pollution model may be associated with a display, which in some examples, corresponds to a projector 200. In systems with multiple displays or projectors, a light pollution model may be determined separately for each display or projector or be determined for one display or projector and applied to the remaining displays or projectors.

Operation 516 includes rendering the scene to the display with the portion of the scene having the final luminance. In at least one example embodiment, multiple pixels or all pixels within the scene may have their luminances adjusted in operation 512 so that the entire displayed scene has reduced or eliminated light pollution compared to the initial signal.

Example embodiments related to operations 512 and 516 are discussed in more detail below starting with a discussion of various equations that are used to adjust an initial luminance value to a final luminance value. When all displays (i.e., projectors 200) have identical or nearly identical display characteristics (e.g., number of pixels, FOV, color range, and the like), which is usually the case, a peak (or maximum) display luminance of 1.0 can be assumed for each display. X.rgb represents a color vector of a pixel which is a linearized rgb luminance value that ranges from a minimum possible value to a maximum possible, such as 0.0 to 1.0. The discussion below avoids the use of nonlinear sRGB encoded integer values (e.g., in the range of 0 to 255 or 0 to 1023) since use of non-linear encoded data is not supported by the below expressions. Using a linear 0 to 1 value is common in graphics rendering documentation and GPU programming because the conversion from linear 0 to 1 values to a display specific encoding (e.g., 0 to 255) is typically not part of the GPU programming interface. However, it should be appreciated that a linear luminance rgb value may have a corresponding nonlinear luminance sRGB value.

Luminance value averaging may be implemented in one or more GPU(s) of the processing circuitry 116, and averages may be computed at frame rate of the video or images being displayed. Real time fill factor computation (FillFactor.rgb) for a scene may be carried out according to the pseudocode below, where “+=” notation is the equivalent of sigma notation indicating a summation operation:
for each display d, for each pixel i

average_fill_factor[d].rgb+=input_pixel[d][i].rgb/#display_pixels[d]

FillFactorSum.rgb+=peak_display_luminance[d]*average_fill_factor[d].rgb

FillFactorMax.rgb+=peak_display_luminance[d]

FillFactor.rgb=FillFactorSum.rgb/FillFactorMax.rgb

In the equations above:
input_pixel[d][i].rgb is the initial luminance of pixel i in display d as initially commanded to be displayed on the screen 204,
#display_pixels [d] is the total number of pixels in display d,
FillFactorSum.rgb is a measure of the overall Fill Factor for all displays d, and
FillFactorMax.rgb is the maximum fill factor value for the system (assumed to be 1.0 in this example).
   As may be appreciated, FillFactor.rgb is the real time fill factor that has been normalized and ranges from 0.0 to 1.0. The real time FillFactor.rgb is then used to apply luminance corrections on a per-pixel (or per-zone) basis.

Per pixel corrections may be implemented in GPU(s) at frame rate according to the pseudocode below which uses the pollution values pollution.rgb from the light pollution model from FIG. 4:
for each display d, for each pixel i in a scene to be displayed, light pollution is determined as:

pollution.rgb=FillFactor.rgb*scattering_coefficient[d][i]

The final luminance value for the pixel may be computed as:

pixel.rgb=input_pixel[d][i].rgb*(1.rgb+pollution.rgb)−pollution.rgb

As noted above, pollution.rgb is a value included with the light pollution model and is indicative of the amount of light pollution for a pixel i and is found by multiplying the real time fill factor value FillFactor.rgb by the scattering coefficient for pixel i. Thereafter, the final luminance pixel.rgb for pixel i is determined by multiplying the initial luminance value input_pixel[d][i].rgb by (1.rgb+pollution.rgb) and then subtracting pollution.rgb from the result, where 1.rgb is a peak luminance color vector of (1, 1, 1).

In some examples, the system implements tone mapping to prevent or mitigate loss of detail in dark areas according to the following pseudocode:
tone_map.rgb=min(pixel.rgb−pollution.rgb, 0.rgb), where 0.rgb is a minimum luminance color vector of (0, 0, 0) and tone_map.rgb is an intermediate value used as an input in the following expression:

output_pixel[d][i].rgb=pixel.rgb+tone_map.rgb*tone_map.rgb/(4*pollution.rgb)

Here, output.pixel[d][i].rgb is a tone mapping operation that restores contrast to pixels with a final luminance value near zero or less than zero by mapping that value to a higher value. Stated another way, the tone mapping operation output.pixel[d][i].rgb may be applied to those pixels with a final luminance value pixel.rgb that is less than zero or so near zero.

In at least one example embodiment, instead of or in addition to the luminance adjustment described in the above equations, operation 512 includes selecting, based on a luminance threshold and the initial luminance from operation 508, a correction factor which may correspond to a weight applied to rgb luminance values or other suitable means for adjusting luminance. Operation 512 may then further include applying the selected correction factor to the portion of the scene to adjust the initial luminance of the portion to the final luminance of the portion. In general, the luminance threshold may be a design parameter set based on empirical evidence and/or preference and may be stored in a memory or database and accessible by the image processing device. For example, the luminance threshold is based on or equal to a leakage level of a projector 200 projecting the portion of the scene to the screen 204. The luminance threshold may be the same or different for multiple or all pixels of the screen 204. Selecting the correction factor as part of operation 512 may include selecting, when the initial luminance is above the luminance threshold, a first correction factor that reduces the initial luminance of the portion of the scene to the final luminance by a first amount that is substantially equivalent to an amount of light pollution predicted for the portion of the scene by the light pollution model. For example, the light pollution model may predict, based on the scattering coefficients computed in method 400, that a luminance value of a first pixel above the luminance threshold induces a known amount of light pollution on one or more neighboring pixels. The first correction factor may then be selected to reduce the first pixel's initial luminance that is above the luminance threshold by an amount that cancels out or substantially reduces the light pollution induced by the first pixel on the neighboring pixels.

Selecting the correction factor as part of operation 512 may include selecting, when the initial luminance is at or below the luminance threshold, a second correction factor that reduces the initial luminance by a second amount that is less than the amount of light pollution predicted for the portion of the scene by the light pollution model. Accordingly, the second amount may be less than the first amount of the first correction factor. In at least one embodiment, the second amount becomes lower as the initial luminance moves further below the luminance threshold. The second amount (the amount of luminance reduction from the initial luminance) may be inversely proportional to the difference between the initial luminance and the luminance threshold. That is, the amount of luminance reduction for the second amount gets smaller as the difference between the initial luminance and the luminance threshold gets larger. Here, it should be appreciated that the second amount may be equal to zero (i.e., the final luminance=the initial luminance) when initial luminance is at a minimum possible luminance achievable by the display system 108. Using the second correction factor, which gradually reduces the amount of correction as the difference between the luminance threshold and the initial luminance becomes larger, enables the system to make smaller luminance corrections than the first correction factor to avoid over-reducing the initial luminance of a pixel as the initial luminance of the pixel approaches the minimum possible luminance for the display system 108 (where the minimum possible luminance is based on the capability of a projector 200 and noise).

In at least one embodiment, operation 512 may take an additional luminance threshold into account that is higher than the luminance threshold mentioned above. If a pixel's initial luminance is determined to be at or above the additional luminance threshold, then a third correction factor may be selected to adjust the initial luminance of a pixel. In this case, the amount of luminance reduction caused by the third correction factor may gradually reduce as the difference between the initial luminance and the additional luminance threshold becomes larger (e.g., the amount of luminance reduction becomes smaller until there is zero modification when the pixel's initial luminance is at a maximum possible luminance for the display system 108). The additional luminance threshold may also be a design parameter set based on empirical evidence and/or preference.

Although not explicitly shown, in at least one embodiment, the method 500 determines whether a pixel's intended color within the scene changes by more than a color difference threshold upon application of the first correction factor or the second correction factor. If so, the first correction factor or second correction factor may be modified (e.g., luminance reduced) so that the pixel's change in color is less than the color difference threshold. If not, the first correction factor or second correction factor may be applied to the pixel without further modification.

In at least one embodiment, the above-mentioned corrector factors may vary based on a time-of-day setting for a flight simulation. For example, the tone map operators for each pixel may be globally adjusted up or down depending on a time of day or ambient light conditions being simulated (e.g., dusk, dawn, daytime sunny, nighttime, cloudy, rainy, snowy, and/or the like). In this manner, the image processing systems, methods and devices of the present disclosure can adjust an initial luminance for any time of day of a scene. In contrast, some related art methods of adjusting luminance work adequately for one time of a day (such as for a scene during daytime), but are inadequate for other times of the day (such as dusk, dawn, and/or nighttime).

Here, it should be appreciated that operation 512 may be carried out on a global basis for the display system 108. That is, the correction factor (e.g., tone map operator) applied to a pixel of a scene may be modified based on the instantaneous light pollution at that pixel as is predicted by the light pollution model in response to the anticipated luminances of all pixels of the scene.

Although correction factors have been described as being selected, it should be appreciated that the correction factors mentioned herein may additionally or alternatively be computed or determined using a suitable equation or equations. In addition, although luminance adjustments and correction factors have been discussed with reference to projector style displays, the same concepts may be applied to other displays such as, LED, OLED, LCD, and the like.

As may be appreciated from the foregoing description, example embodiments provide improved contrast ratio perception for a viewer (e.g., contrast improvement with the above described adjustments implemented by software). In addition, example embodiments may decrease the intensity of light emitted from a projector, thereby extending the lifetime of the projector's system (e.g., extended bulb life). Example embodiments may also enable lower quality projector's to produce high quality images on a screen.

In view of the present disclosure, example embodiments relate to a method that includes displaying a calibration image on the display, capturing, with one or more image sensors, the calibration image displayed on the display, and determining light pollution for zones of the calibration image displayed on the display. In one embodiment, equal sized black/white latitude stripes propagate from pole to pole while one or more industrial cameras collect the per pixel linear peak white/black signal levels. The operation repeats for non-equal sized black/white latitude stripes. The method may include generating a correction factor for each zone of the calibration image based on the determined light pollution, and generating a light pollution model based on at least one calibration operation. In at least one embodiment, a camera pixel to display pixel mapping is used to transform the data from camera to display space. In addition, per-pixel light pollution models are derived from the data and recorded for later use. The method may further include determining an initial luminance for a portion of a scene to be displayed on a display, and adjusting the initial luminance for the portion of the scene to a final luminance based on a light pollution model to compensate for light pollution when the scene is displayed on the display. In one embodiment, an initial image to be displayed is obtained. For said initial image, a light pollution correction is computed for each pixel's color value (Red, Green, Blue), using the light pollution model(s). The light pollution correction is smoothly damped toward zero for very low color values (e.g., a “very low color value” may contribute less than 1 percent of peak white intensity), which may prevent or mitigate loss of detail in very dark areas of the image, by keeping the correction from subtracting pollution of a magnitude from a color value of lesser magnitude. In addition, the light pollution correction is smoothly damped toward zero when corrected color values deviate from initial color values by a color difference threshold (e.g., a “color difference threshold” may be a value of 1.0 in CIELAB delta E color coordinates, e.g., https://en.wikipedia.org/wiki/Color_difference), which may ensure that image color does not noticeably change. The method may finally include rendering the scene to the display with the portion of the scene having the final luminance. In one embodiment, each image generator channel applies the per pixel, per color, light pollution correction to the output frame buffer in a post processing step just prior to transmission to the display device. The method above repeats for each ensuing image at the frame rate of the display system.

It should be appreciated that inventive concepts cover any embodiment in combination with any one or more other embodiment, any one or more of the features disclosed herein, any one or more of the features as substantially disclosed herein, any one or more of the features as substantially disclosed herein in combination with any one or more other features as substantially disclosed herein, any one of the aspects/features/embodiments in combination with any one or more other aspects/features/embodiments, use of any one or more of the embodiments or features as disclosed herein. It is to be appreciated that any feature described herein can be claimed in combination with any other feature(s) as described herein, regardless of whether the features come from the same described embodiment. A system on a chip (SoC) including any one or more of the above aspects.

Example embodiments may be configured according to the following:

(1) A method of reducing light pollution in a displayed image, the method comprising:
receiving a portion of a scene to be displayed on a display with an initial luminance;
adjusting the initial luminance for the portion of the scene to a final luminance based on a light pollution model associated with the display; and
rendering the scene to the display with the portion of the scene having the final luminance.
   (2) The method of (1), further comprising:
generating the light pollution model based on at least one calibration operation.
   (3) The method of one or more of (1) to (2), wherein the at least one calibration operation includes:
displaying a calibration image on the display;
capturing, with one or more image sensors, the calibration image displayed on the display; and
determining light pollution for one or more zones of the calibration image based on the captured calibration image.
   (4) The method of one or more of (1) to (3), wherein the calibration image includes a black and white image with a repeating pattern.
   (5) The method of one or more of (1) to (4), wherein determining the light pollution for the one or more zone of the calibration image includes:
determining scattering coefficients for the one or more zone of the captured calibration image.
   (6) The method of one or more of (1) to (5), wherein each zone of the captured calibration image corresponds to a single pixel of the display.
   (7) The method of one or more of (1) to (6), further comprising:
generating a correction factor for each zone of the calibration image based on the determined scattering coefficients.
   (8) The method of one or more of (1) to (7), wherein the correction factor includes a tone map operator for luminance adjustments.
   (9) The method of one or more of (1) to (8), wherein adjusting the initial luminance of the portion of the scene to the final luminance based on the light pollution model includes:
selecting, based on a luminance threshold and the initial luminance, a correction factor; and
applying the selected correction factor to the portion of the scene to adjust the initial luminance to the final luminance.
   (10) The method of one or more of (1) to (9), wherein selecting the correction factor includes selecting, when the initial luminance is above the luminance threshold, a first correction factor that reduces the initial luminance of the portion of the scene by a first amount to the final luminance, the first amount being substantially equivalent to an amount of light pollution predicted for the portion of the scene by the light pollution model.
   (11) The method of one or more of (1) to (10), wherein selecting the correction factor includes selecting, when the initial luminance is at or below the luminance threshold, a second correction factor that reduces the initial luminance by a second amount that is less than the amount of light pollution predicted for the portion of the scene by the light pollution model, the second correction factor being different than the first correction factor.
   (12) The method of one or more of (1) to (11), wherein the second amount becomes lower as the initial luminance moves further below the luminance threshold.
   (13) The method of one or more of (1) to (12), wherein the portion of the scene corresponds to a single pixel.
   (14) An apparatus for reducing light pollution in a displayed image, the apparatus comprising:
processing circuitry to:
   receive a portion of a scene to be displayed on a display with an initial luminance;
   adjust the initial luminance for the portion of the scene to a final luminance based on a light pollution model associated with the display; and
   render the scene to the display with the portion of the scene having the final luminance.
      (15) The apparatus of (14), wherein the processing circuitry adjusts the initial luminance of the portion of the scene to the final luminance based on the light pollution model by:
selecting, based on a luminance threshold and the initial luminance, a correction factor; and
applying the selected correction factor to the portion of the scene to adjust the initial luminance to the final luminance.
   (16) The apparatus of one or more of (14) to (15), wherein selecting the correction factor includes selecting, when the initial luminance is at or below the luminance threshold, a first correction factor that reduces the initial luminance by a first amount that is less than an amount of light pollution predicted for the portion of the scene by the light pollution model.
   (17) The apparatus of one or more of (14) to (16), wherein the first amount becomes lower as the initial luminance moves further below the luminance threshold.
   (18) The apparatus of one or more of (14) to (17), wherein selecting the correction factor includes selecting, when the initial luminance is above the luminance threshold, a second correction factor that reduces the initial luminance of the portion of the scene by a second amount to the final luminance, the second amount being substantially equivalent to the amount of light pollution predicted for the portion of the scene by the light pollution model.
   (19) The apparatus of one or more of (14) to (18), wherein the portion of the scene corresponds to a single pixel of the display.
   (20) A system to reduce light pollution in a displayed image, the system comprising:
processing circuitry to:
   determine initial luminances for pixels in each frame of a plurality of frames of a video signal to be displayed on a display;
   adjust, on a frame-by-frame basis, the initial luminances for the pixels in each frame to final luminances based on a light pollution model that compensates for light pollution that occurs when each frame is displayed on the display; and
   render each frame to the display with the pixels having the final luminances.
      (21) A method for calibrating a display system, the method comprising:
displaying a calibration image on a display;
capturing, with one or more image sensors, the calibration image displayed on the display; and
determining light pollution for zones of the calibration image based on the captured calibration image; and
generating a light pollution model based on the determined light pollution for the zones.
   (22) The method of (21), wherein the calibration image includes a black and white image with a repeating pattern.
   (23) The method of one or more of (21) to (22), wherein determining the light pollution for the zones of the calibration image includes:
determining scattering coefficients for zones of the captured calibration image.
   (24) The method of one or more of (21) to (23), wherein each zone of the captured calibration image corresponds to a single pixel of the display.
   (25) A system, comprising:
a screen;
one or more projectors that project images onto the screen;
one or more image sensors; and
image processing circuitry to:
   render a calibration image to the screen using the one or more projectors;
   control the one or more image sensors to capture the calibration image displayed on the screen; and
   determine light pollution for zones of the calibration image based on the captured calibration image; and
   generate a light pollution model based on the determined light pollution for the zones.
      (26) The system of (25), wherein the calibration image includes a black and white image with a repeating pattern.
      (27) The system of one or more of (25) to (26), wherein determining the light pollution for the zones of the calibration image includes:
determining scattering coefficients for zones of the captured calibration image.
   (28) The system of one or more of (25) to (27), wherein each zone of the captured calibration image corresponds to a single pixel of the screen.

What is claimed is:

1. A method of reducing light pollution in a displayed image, the method comprising:
receiving a portion of a scene to be displayed on a display with an initial luminance;
adjusting the initial luminance for the portion of the scene to a final luminance based on a light pollution model associated with the display; and
rendering the scene to the display with the portion of the scene having the final luminance.

2. The method of claim 1, further comprising:
generating the light pollution model based on at least one calibration operation.

3. The method of claim 2, wherein the at least one calibration operation includes:
displaying a calibration image on the display;
capturing, with one or more image sensors, the calibration image displayed on the display; and
determining light pollution for one or more zones of the calibration image based on the captured calibration image.

4. The method of claim 3, wherein the calibration image includes a black and white image with a repeating pattern.

5. The method of claim 3, wherein determining the light pollution for the one or more zones of the calibration image includes:
determining scattering coefficients for the one or more zones of the captured calibration image.

6. The method of claim 5, wherein each zone of the captured calibration image corresponds to a single pixel of the display.

7. The method of claim 5, further comprising:
generating a correction factor for each zone of the calibration image based on the determined scattering coefficients.

8. The method of claim 7, wherein the correction factor includes a tone map operator for luminance adjustments.

9. The method of claim 1, wherein adjusting the initial luminance of the portion of the scene to the final luminance based on the light pollution model includes:
selecting, based on a luminance threshold and the initial luminance, a correction factor; and
applying the selected correction factor to the portion of the scene to adjust the initial luminance to the final luminance.

10. The method of claim 9, wherein selecting the correction factor includes selecting, when the initial luminance is above the luminance threshold, a first correction factor that reduces the initial luminance of the portion of the scene by a first amount to the final luminance, the first amount being substantially equivalent to an amount of light pollution predicted for the portion of the scene by the light pollution model.

11. The method of claim 10, wherein selecting the correction factor includes selecting, when the initial luminance is at or below the luminance threshold, a second correction factor that reduces the initial luminance by a second amount that is less than the amount of light pollution predicted for the portion of the scene by the light pollution model, the second correction factor being different than the first correction factor.

12. The method of claim 11, wherein the second amount becomes lower as the initial luminance moves further below the luminance threshold.

13. The method of claim 1, wherein the portion of the scene corresponds to a single pixel.

14. An apparatus for reducing light pollution in a displayed image, the apparatus comprising:
processing circuitry to:
receive a portion of a scene to be displayed on a display with an initial luminance;
adjust the initial luminance for the portion of the scene to a final luminance based on a light pollution model associated with the display; and
render the scene to the display with the portion of the scene having the final luminance.

15. The apparatus of claim 14, wherein the processing circuitry adjusts the initial luminance of the portion of the scene to the final luminance based on the light pollution model by:
selecting, based on a luminance threshold and the initial luminance, a correction factor; and
applying the selected correction factor to the portion of the scene to adjust the initial luminance to the final luminance.

16. The apparatus of claim 15, wherein selecting the correction factor includes selecting, when the initial luminance is at or below the luminance threshold, a first correction factor that reduces the initial luminance by a first amount that is less than an amount of light pollution predicted for the portion of the scene by the light pollution model.

17. The apparatus of claim 16, wherein the first amount becomes lower as the initial luminance moves further below the luminance threshold.

18. The apparatus of claim 16, wherein selecting the correction factor includes selecting, when the initial luminance is above the luminance threshold, a second correction factor that reduces the initial luminance of the portion of the scene by a second amount to the final luminance, the second amount being substantially equivalent to the amount of light pollution predicted for the portion of the scene by the light pollution model.

19. The apparatus of claim 14, wherein the portion of the scene corresponds to a single pixel of the display.

20. A system to reduce light pollution in a displayed image, the system comprising:
processing circuitry to:
determine initial luminances for pixels in each frame of a plurality of frames of a video signal to be displayed on a display;
adjust, on a frame-by-frame basis, the initial luminances for the pixels in each frame to final luminances based on a light pollution model that compensates for light pollution that occurs when each frame is displayed on the display; and
render each frame to the display with the pixels having the final luminances.
